(19) United States
(12) Patent Application Publication
(10) Pub. No.: US 2007/0203592 A1
(43) Pub. Date: Aug. 30, 2007

(54) System for storing and displaying baseball little league game data

(76) Inventor: Carter Pennington, Wappingers Fall, NY (US)

Correspondence Address: GOTTLIEB RACKMAN & REISMAN PC, 270 MADISON AVENUE, 8TH FLOOR, NEW YORK, NY, 100160601, US

(21) Appl. No.: 11/365,361

(22) Filed: Feb. 28, 2006

(51) Int. Cl. G06F 19/00

(52) U.S. Cl. 700/92

(57) ABSTRACT

A portable, calculator-size, easy to use Little League baseball game score keeper that can be used to enter, save and display baseball game information, including game and season histories.

### RELATED APPLICATIONS

None.

### BACKGROUND OF THE INVENTION

A. Field of the Invention

This invention relates to a game score keeper and, more particularly, a portable baseball game score keeper that can be used to record, maintain and display scores of baseball games, especially Little League games, including the recall of data by game and season.

B. Description of the Prior Art

Sports fans have long recorded and stored scores of games, including scores of baseball games. However, the known recording approaches use large, stationary scoreboards, such as those at stadiums, or computers (even laptops) that cannot be easily carried in a pocket. Heavy, bulky score-keeping gear is encumbering, especially at Little League games where parents usually come to watch baseball games with their children.

The disadvantages of the prior art devices are that they are large, complex units, with complicated controls, requiring extensive knowledge of operating principles to keep and save scores. Furthermore, existing devices do not have a feature that allows the user to save individual and season game histories and recall a history at a later date.

What is needed is a portable game score keeping system, with a hand-held calculator-size housing, that can also save and recall game score information including dates, times, and personal game notes. Preferably, to keep operation simple, the unit should have a minimum number of function keys.

### SUMMARY OF THE INVENTION

The storage and display system for keeping and retrieving scores of games (referred to as “score keeper” or “unit” herein) is a microprocessor based electronic unit designed for assisting the user with keeping track of ongoing games and storing scores of baseball games. Modifications may be made to the processing system and to the program/software running on the score keeper to adapt the score keeper to sports other than baseball including, but not limited to, football, basketball, hockey, soccer, tennis, golf, billiards, and ping-pong. The unit preferably has a large display (preferably at least 60 mm×44 mm) and a membrane keyboard for easy and direct key entry. The term “key” includes the term “button” in this application because a keyboard with buttons may be used in place of a membrane keyboard with keys. The preferred type of display is a Dot Matrix Liquid Crystal Display (LCD). The score keeper is menu driven, so a user can start using it without going through detailed instructions. The score keeper housing should be waterproof under normal rain and moisture conditions to allow outdoor use.

The score keeper is compact in size (the preferred dimensions are approximately 120 mm wide×80 mm high×11 mm thick). It is powered by a battery, preferably a high capacity lithium battery (such as CR2032 or equivalent), which allows for over 400 hours of continuous use. A low battery warning will remind the user to change the battery well before the unit has to power down. The unit will also turn off automatically if no button is pressed for 20 minutes (or shorter) to save power (such features are standard in the art and are not further disclosed herein).

The software of the device is designed to be extremely user friendly. All entries for Balls, Strikes, Outs and Runs are made by pressing the designated keys, which instantly cause displays of applicable information on the screen. Total scores are automatically calculated as the game progresses. Game ending logic is automatic, and the score keeper will display a winning or loosing message along with a W-L-T (Win-Loss-Tie) season record. A three-step back corrective action is allowed so that the user can amend incorrect key inputs in normal cases. A menu mode is also provided for the user to change settings or to perform other relevant functions during the game.

Games are saved in the unit by using memory, preferably a non-volatile memory (serial flash memory) in which data is maintained during power out and battery changes. Games can be saved as a group in various Season Folders: Little League Season, Tournament (1 and 2) and Fall Ball. Results can be reviewed at any time. The memory can preferably hold game data for up to 500 games.

### BRIEF DESCRIPTION OF THE DRAWINGS

The features and advantages of the score keeper will become further understood with reference to the following description, appended claims and accompanying drawings, in which:

FIG. 1 is a block diagram of the root operations of the score keeper;

FIG. 2 is a block diagram of the score keeping process using the score keeper;

FIG. 3 is a block diagram of the corrections and review process using the score keeper;

FIG. 4 is a block diagram of the settings process available in the score keeper;

FIG. 5 is a block diagram of exiting-the-game and saving-the-game-result processes using the score keeper;

FIG. 6 is a block diagram of the menu options available to the user of the score keeper;

FIG. 7 is a diagram of the external layout of the preferred embodiment of the score keeper;

FIG. 8 is a diagram of the internal layout of the score keeper of FIG. 7; and

FIGS. 9-11 depict some of the more important screens that are displayed during use of the device.

### DETAILED DESCRIPTION OF THE PREFERRED EMBODIMENT

The display screen is preferably a Liquid Crystal Display (LCD) screen, and it is preferably a dot matrix LCD with a resolution of 48 rows by 84 columns. The housing is preferably a hand-held calculator-size housing.

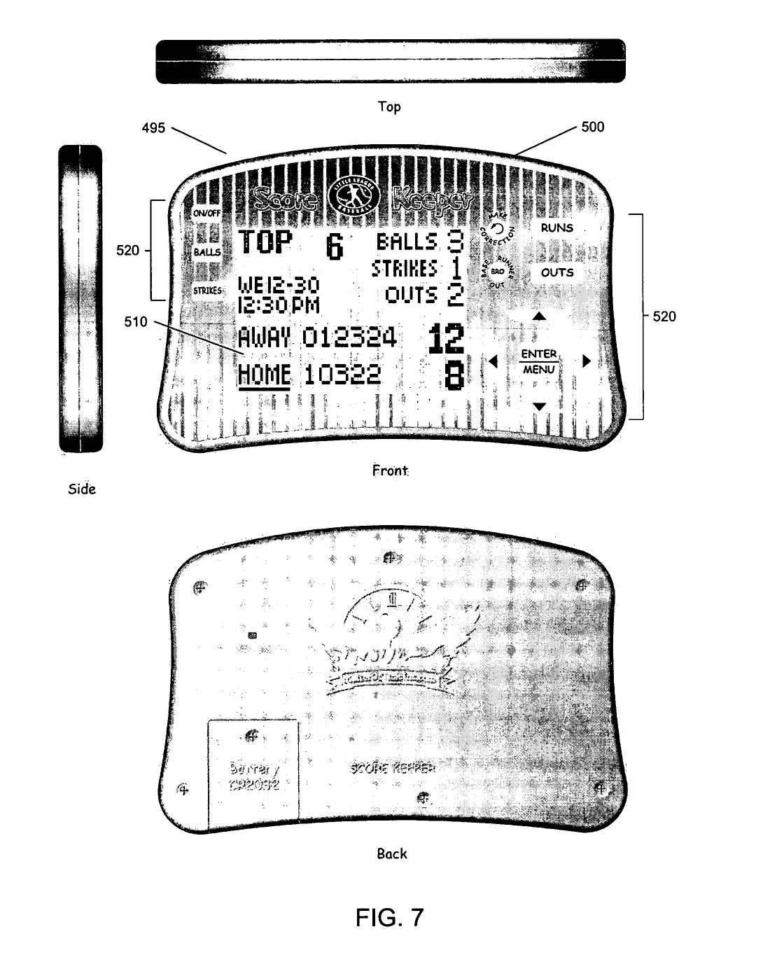

The user interface (keyboard) is preferably a waterproof membrane keyboard with a minimal number of keys, but the score keeper can also use a keyboard with buttons. Preferably, the set of keys of the user interface serves no function other than storing and retrieving scores of baseball games, and the storage and display system preferably has no keys that relate to score keeping other than this set of keys. In addition to an On/Off key, the following function keys are included (see FIG. 7):

| Key | Function |
|---|---|
| BALLS | add 1 to the Balls count |
| STRIKES | add 1 to the Strikes count |
| OUTS | add 1 to the Outs count |
| BRO (Base | add 1 to the Outs count without changing |
| Runner Out) | Balls and Strikes counts |
| RUNS | add 1 to the score for the team up at bat |
| | (if at top of inning add to Away team, if |
| | at bottom of inning add to Home team) |
| MAKE | make correction by canceling the last key input. |
| CORRECTION | |
| ENTER/MENU | 1. Enter menu mode during score keeping |
| | 2. Confirm selection/data entry in menu mode |
| Left Arrow | cursor in menu mode |
| Right Arrow | cursor in menu mode |
| Up Arrow | cursor in menu mode |
| Down Arrow | cursor in menu mode |

The display is shown in FIG. 7 and is self-explanatory. The function keys have already been described. The current counts for balls, strikes and outs are displayed as is the inning (the 6th inning being shown) and the half (top or bottom). The day of the week, time and date are displayed. Below them, either AWAY or HOME is underlined to indicate the user's team. The runs scored during each inning for each team are shown, as are the totals in bold numerals.

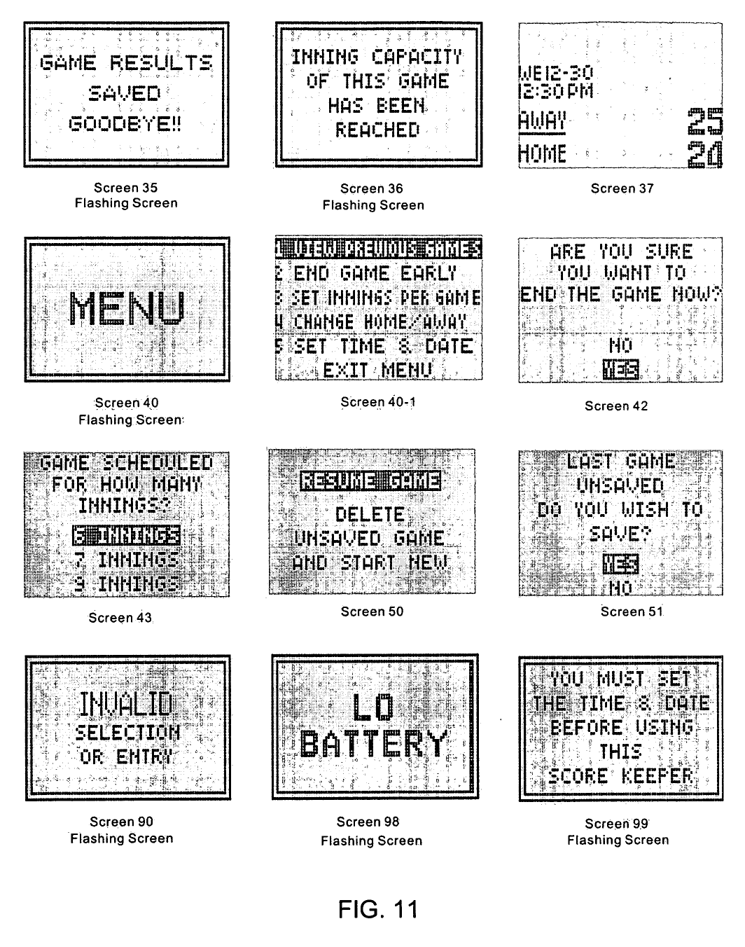

When the score keeper is initially powered on, the score keeper will display a message “YOU MUST SET THE TIME & DATE BEFORE USING THIS SCORE KEEPER” (FIG. 11, Screen 99).

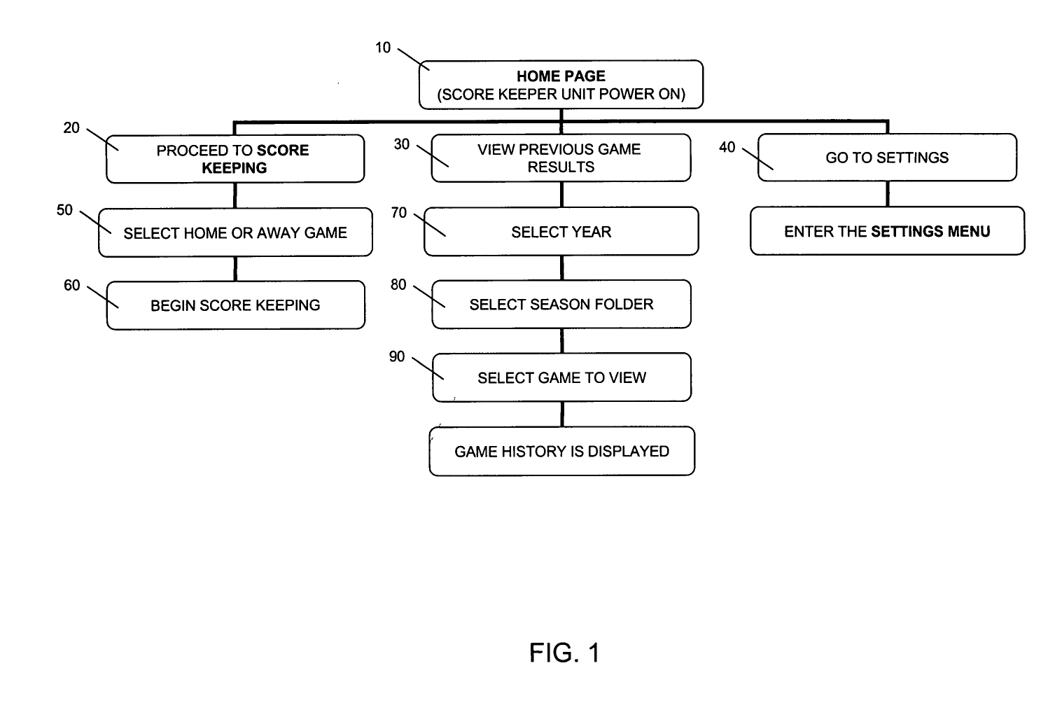

With reference to FIG. 1, a user of the score keeper device has access to the following options when the device is powered on and the Home Page 10 comes up on the screen: “Proceed to Score Keeping” 20, “View Previous Game Results” 30, and “Go to Settings” 40 (Screen 1). A selection is made by using the cursor keys followed by pressing the “Enter/Menu” key. Selecting “Proceed to Score Keeping” 20 allows the user to select whether the game is “Home” or “Away” 50 (Screen 11), and to begin the “Score Keeping” process 60. Selecting “View Previous Game Results” 30 (Screen 12) gives the user access to the following choices: select “Year” 70 (Screen 12.1), then “Select Season Folder” 80 (such as Little League, Tournament 1, Tournament 2, and Fall Ball or Current Season) (Screens 12.2A, 12.2B), and then select the appropriate game to view 90, after which the results of the selected game are displayed on the screen (Screen 12.3). For all cases, available options are shown on the display, and the user selects one of them using the cursor keys and the “Enter/Menu” key.

If no key is pressed for twenty minutes while in the Score Keeping process 60, the score keeper will turn off, and all the data will be retained. When the score keeper is turned on again, it will give the user the following options: “RESUME GAME” and “DELETE UNSAVED GAME AND START NEW” (Screen 50). When the score keeper is turned on after an automatic shut down in the previous year, the score keeper will prompt the user “LAST GAME UNSAVED, DO YOU WISH TO SAVE?” (Screen 51), and the user can select “YES” or “NO” with the cursor keys. When the score keeper detects that the battery has less than 10% of its charge remaining, the score keeper will display a message “LOW BATTERY” (Screen 98).

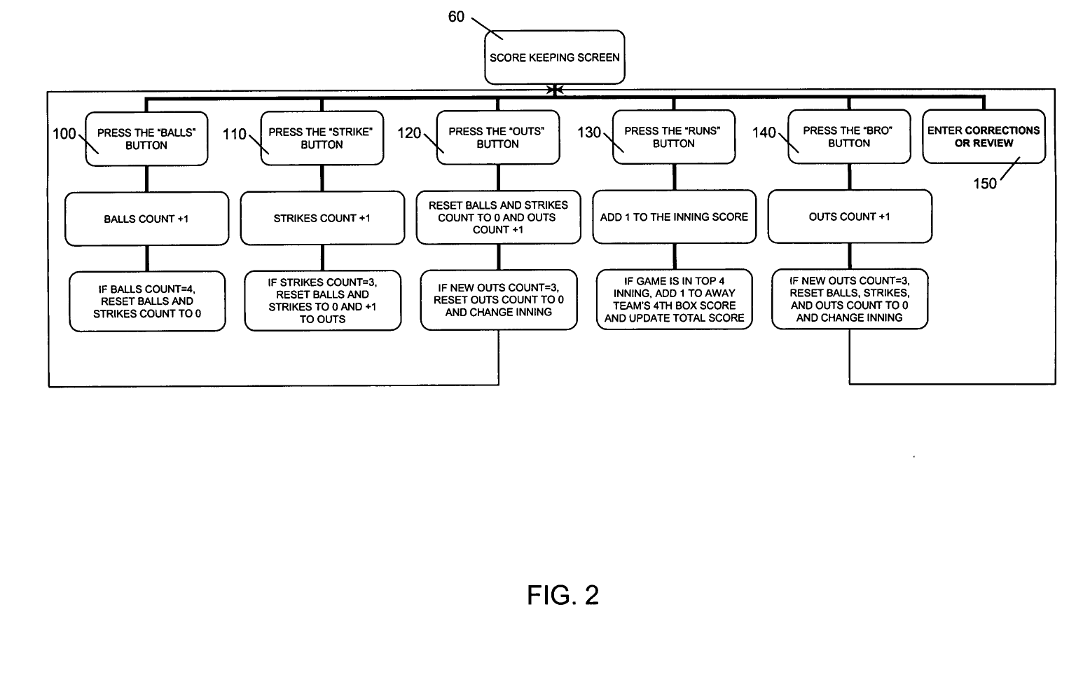

With reference to FIG. 2, the “Score Keeping” process 60 can be subdivided into the following sequences from the score keeping screen (Screen 21), which is driven by the score keeper's computer logic (program):
1. Pressing the “Balls” key 100 adds 1 to the Balls count. If the “Balls” key is pressed when the current Balls count is 3 (i.e., the new Balls count would otherwise be 4), the score keeper will reset the Balls and Strikes counts to 0.
2. Pressing the “Strikes” key 110 adds 1 to the Strikes count (Screen 23). If the “Strikes” key is pressed when the Strikes current count is 2 (i.e., the new Strikes count would otherwise be 3), the score keeper will reset Balls and Strikes counts to 0 and add 1 to the Outs count.
3. Pressing the “Outs” key 120 resets Balls and Strikes counts to 0 and adds 1 to the Outs count (Screen 24). When the third out is reached (i.e., the Outs count would otherwise be 3), the score keeper will reset Outs to 0 and advance to the next half inning (a message will be displayed every time when an inning is changed, e.g., HEADING INTO THE BOTTOM OF THE 1^{st}) (Screen 22), or change the inning if appropriate.
4. Pressing the “Runs” key 130 adds 1 to the Inning score (the corresponding inning box score on the score keeper screen will increase by 1 when the Runs button is pressed) (Screen 24). The total score at the rightmost part of the display (FIG. 7) will change at the same time to reflect the updated total score. If the game is in the top of the 4th inning, the score keeper will add 1 to the Away team's 4th box score and update the total score.
5. Pressing the “BRO” (Base Runner Outs) key 140 adds 1 to the Outs count, but the Balls and Strikes counts are not affected (Screen 25). The Balls and Strikes will only be reset to 0 if pressing the BRO key makes the 3rd Out (i.e., the Outs count would otherwise be 3)—then the score keeper will reset the Balls, Strikes, and Outs counts to 0 and change the inning.
6. Pressing the “Make Correction,” “Left Arrow” or “Enter/Menu” keys will enter the Corrections or Review mode 150 (Screen 26).

A reminder message “FULL COUNT” will appear if the Balls count is 3 and the Strikes count is 2 (Screen 24). It will disappear once the 3rd out is made or when the Balls count increments to 4.

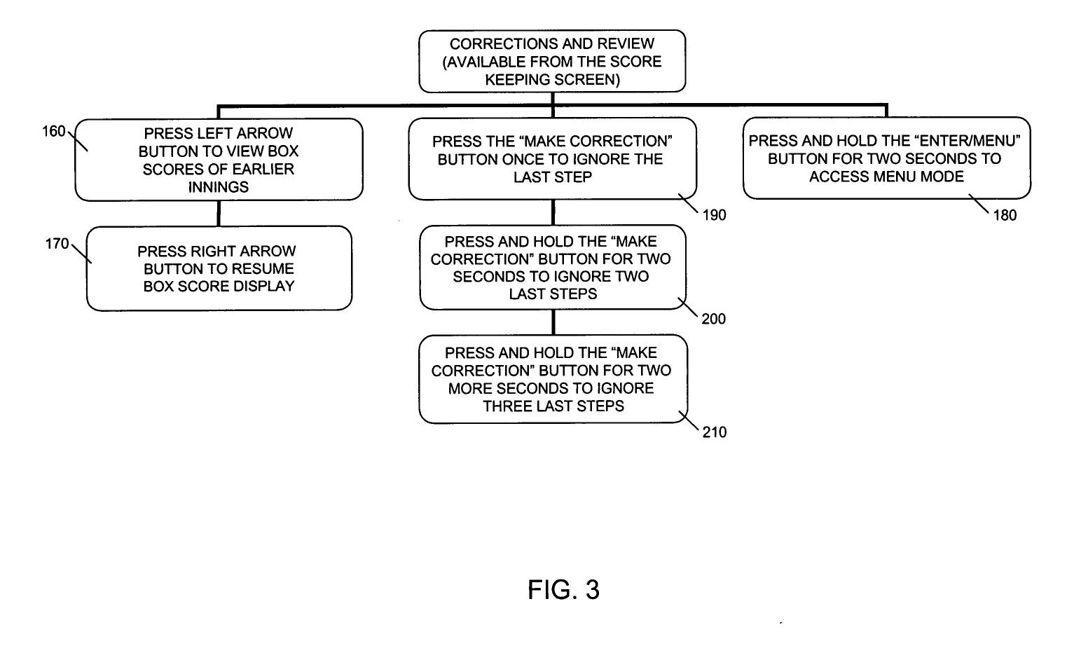

With reference to FIG. 3, when in the Corrections and Review mode 150 of FIG. 2, pressing the Left Arrow key 160 allows the user to view the scores of earlier innings. Pressing the Right Arrow key 170 allows the user to return to the normal box score display. Pressing and holding the “Enter/Menu” key for two seconds 180 allows the user to access menu mode. Pressing the “Make Correction” key once 190 tells the system to ignore the last step the user entered into the score keeper. Pressing and holding the “Make Correction” key for two seconds 200 causes the last two steps to be ignored. The user can cause the last three steps entered to be ignored, by pressing and holding the “Make Correction” key for yet two more seconds 210.

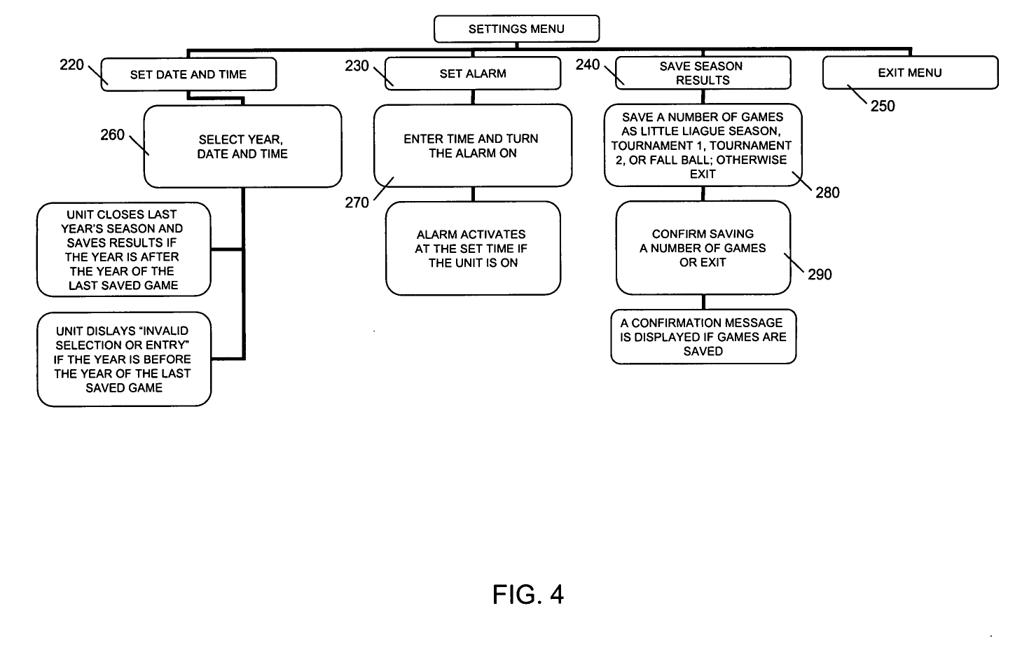

With reference to FIG. 4, the Settings Menu, accessible from the Home Page 10 (FIG. 1) by selecting “Go to Settings” 40, gives the user four options: Set Date and Time 220, Set Alarm 230, Save Season Results 240, and Exit Menu 250 (Screen 13). The user uses Up and Down Arrow (cursor) keys to select the desired option and presses the “Enter/Menu” key to confirm the selection. To Set Date and Time 220, the user selects year, date and time 260 (Screen 14). The score keeper will close the last year's season and save the results if the new year entered is after the year of the last saved game (Screen 14.1). The score keeper will also display an error message if the new year entered is before the year of the last saved game. To Set the Alarm 230, the user has to enter the time and turn the alarm on 270 (Screen 15). Standard procedures for setting these parameters may be used. The score keeper will activate the alarm at the preset time if the score keeper is powered on at that time.

Also with reference to FIG. 4, to Save Season Results 240 (Screen 16), the user selects 280 whether to save the games in a selected season folder as Little League Season, Tournament 1, Tournament 2 or Fall Ball by pressing Up and Down Arrow keys to select the desired option (Screen 16.1) and pressing the “Enter/Menu” key 290 to confirm the selection (Screen 16.2). The score keeper displays a confirmation message when the games are saved (Screen 16.3). Individual games of the current season are saved in the memory in a “current games” folder. Upon the end of a season, the user can save the games in a selected season folder and then start a new group of games in the next folder. A folder can be named by displaying the alphabet on the system and using the cursor and “Menu/Enter” keys to select letters. This way, games are saved in an organized manner and it will be easy for the user to review the results of these games in the future. Saving of games in a folder is also done automatically when the year is over, making the score keeper ready to start keeping scores of new games once the next season begins.

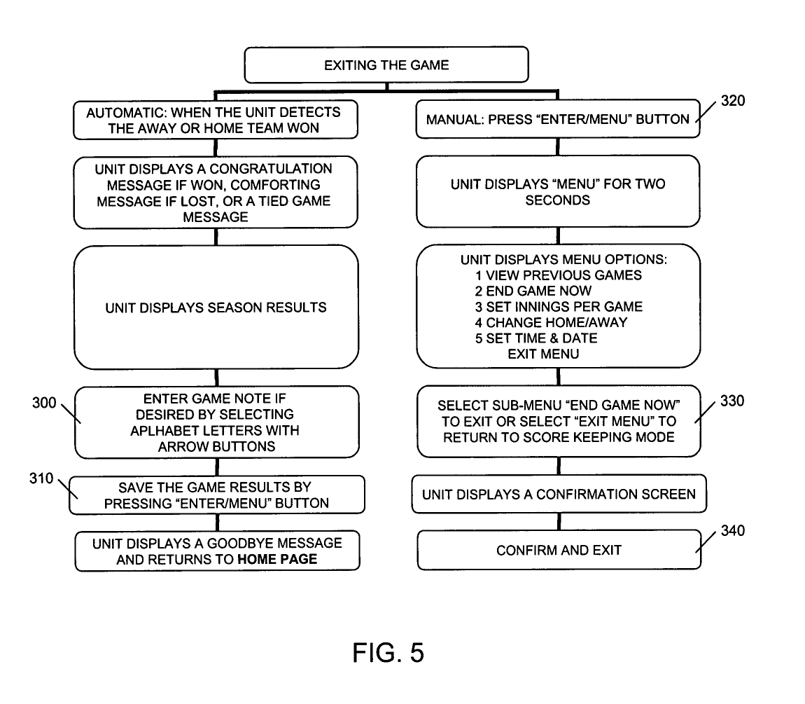

With reference to FIG. 5, ending a game is possible in one of two ways: either manually, or automatically when the score keeper detects that either the Away or the Home team has won and automatically ends the score keeping. The score keeper displays the game results, but it also displays a congratulatory message if the user's team wins (Screens 31A, 31B, 31C, and 31D). An appropriate message is also displayed if the user's team looses (Screen 31E) or the game is a tie (Screen 31F). The score keeper then displays the season cumulative game results (Screen 32). Then, the user can decide whether to enter some game note by pressing Arrow keys 300 (Screen 33) or simply answer “no” and let the unit save the results in the memory. A note is written using the same common technique used for naming a folder (Screen 34). The user saves the game results by pressing the “Enter/Menu” key 310. All games are date marked. A confirmation screen will appear just before the score keeper saves the data, asking the user if he or she really wants to save the game results in case the user does not really want to save them. Then, the score keeper displays a goodbye message (Screen 35) and returns to the Home Page 10. If the game is still a tie when the Outs count is 3 at the bottom of the 18th inning, the score keeper will display a message “INNING CAPACITY OF THIS GAME HAS BEEN REACHED, ENTER SCORES MANUALLY” (Screen 36), and user can then manually enter the scores by using the cursor keys and the “Enter/Menu” key (Screen 37).

Also with reference to FIG. 5, the manual ending of a game is accomplished by the user pressing the “Enter/Menu” key 320. The score keeper displays “MENU” for two seconds (Screen 40), and then it displays the menu options (Screen 40-1), one of which is “END GAME EARLY” 330, which means now. The user can end the game by selecting this option with the Arrow keys, or the user can come back to the Score Keeping process 60 by selecting the “EXIT MENU” option. When the user chooses to end the game, the score keeper displays a confirmation screen (Screen 42), and the user confirms by selecting “YES” and pressing the “Enter/Menu” button 340, after which the score keeper exits.

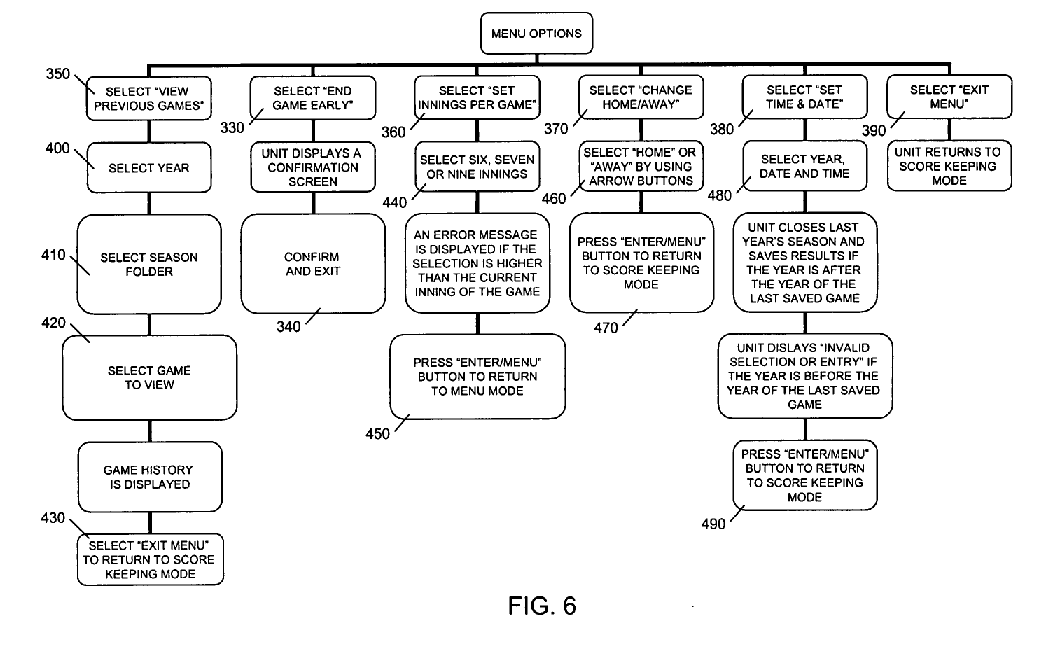

With reference to FIG. 6, the menu options available to the user by pressing the “Enter/Menu” key 320 are: “VIEW PREVIOUS GAMES” 350, “END GAME EARLY” 330, “SET INNINGS PER GAME” 360, “CHANGE HOME/AWAY” 370, “SET TIME & DATE” 380, and “EXIT MENU” 390 (Screen 40-1), the latter selection causing the score keeper to return to the Score Keeping process 60. When the user selects “VIEW PREVIOUS GAMES” 350, the user can select the year 400, select the season folder 410, and select a particular game to view 420. The score keeper then displays the history of that game on the screen. The user can select “EXIT MENU” 430 at any time to return to the Score Keeping process 60. When the user selects “END GAME EARLY” 330 from the menu options, the score keeper displays a confirmation screen, and the user confirms by selecting “YES” and pressing the “Enter/Menu” button 340, after which the score keeper exits.

Also with reference to FIG. 6, selecting “SET INNINGS PER GAME” 360 allows the user to select the number of innings 440, the available numbers being six, seven, and nine innings (Screen 43). The score keeper will display an error message (Screen 90) if the selection is lower than the current inning of the ongoing game. The user can return to the Score Keeping process 60 by pressing the “Enter/Menu” key 450. Selecting “CHANGE HOME/AWAY” 370 allows the user to select a “HOME” or “AWAY” type of game by using Arrow keys 460 and to return to the Score Keeping process 60 by pressing the “Enter/Menu” key 470. Selecting “SET TIME & DATE” 380 allows the user to select the year, date and time 480 and to return to the Score Keeping process 60 by pressing the “Enter/Menu” key 490. The score keeper will close the last year's season and save the season results if the year that was set is after the year of the last saved game. The score keeper will also display the message “INVALID SELECTION OR ENTRY” (Screen 90) if the year that was set is before the year of the last saved game.

FIG. 7 shows the exterior of the preferred embodiment of the score keeper unit 495. The score keeper has a housing 500 with a display 510 viewable by a user and a user interface 520 located on the surface of the housing 500 and operable by the user to input, save and recall game information. The housing 500 is preferably portable and waterproof. Also, the housing 500 preferably has a compartment or several compartments for storing internal components. The score keeper is designed to be effective with a minimal number of buttons/keys, and many functions in the score keeper unit 495 are designed to be automatic.

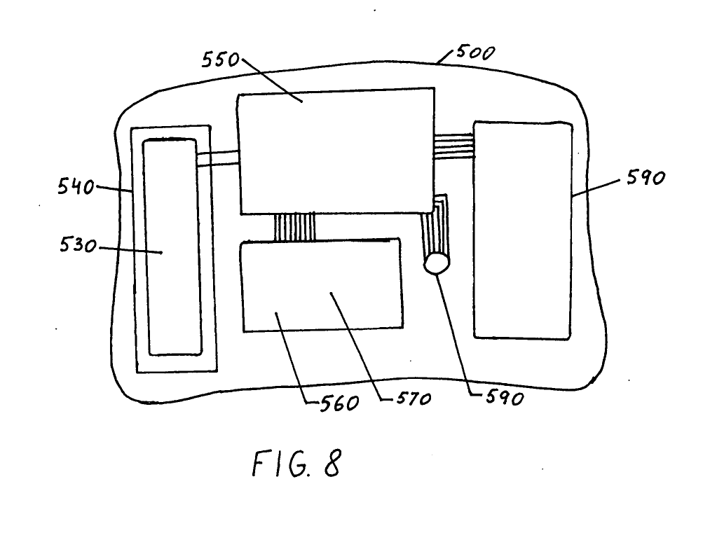

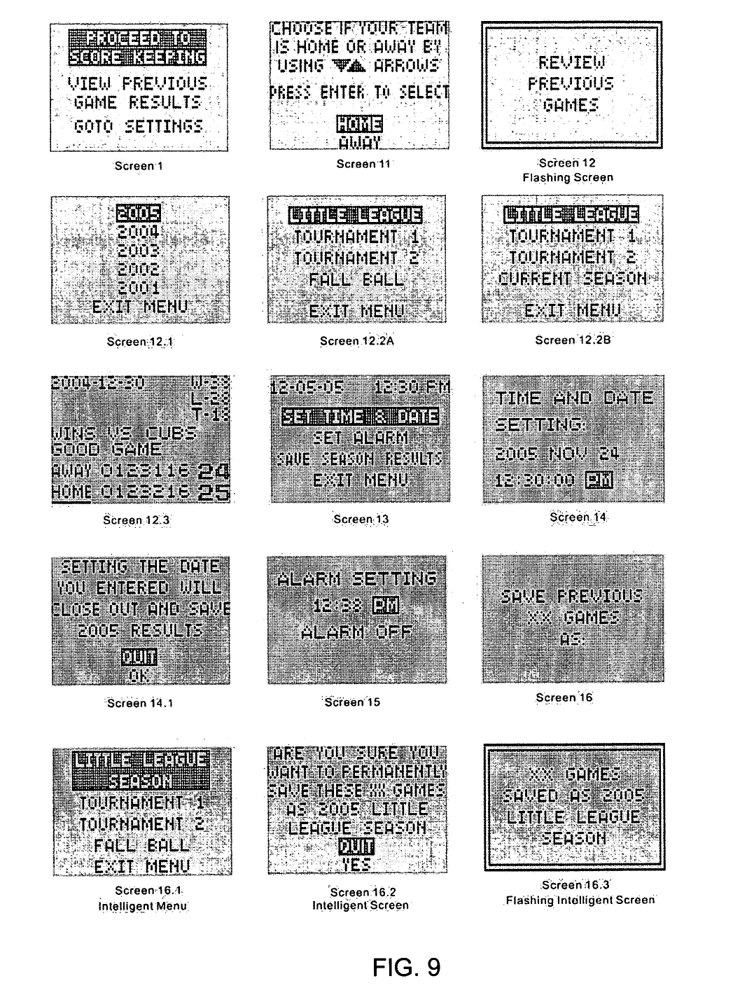

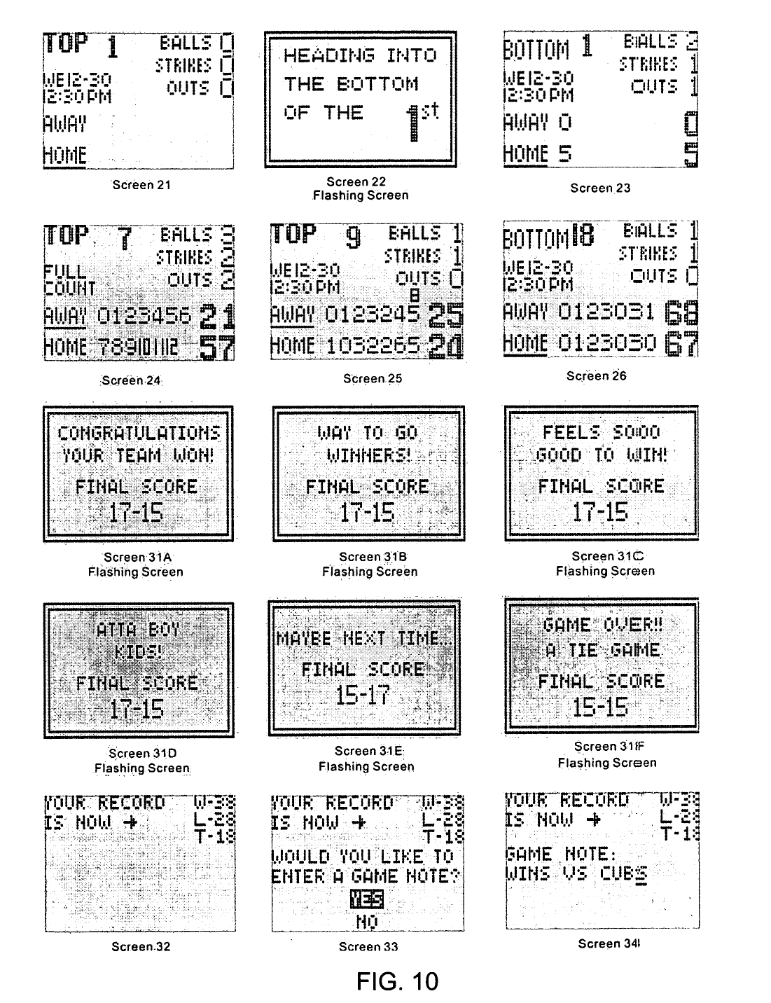

With reference to FIG. 8, which illustrates the internal components of the score keeper unit 495, the preferred embodiment of the invention also includes a battery 530 for providing power to the score keeper, preferably a high capacity lithium battery. The score keeper may also include a battery compartment 540 in the housing 500, capable of receiving a replacement battery when the score keeper battery 530 runs out. The score keeper 495 further includes a processing system 550 for inputting and storing of game information in a memory 560 connected to the processing system 550. The memory 560 is a read/write memory, preferably a non-volatile memory or flash memory. The processing system 550 causes game information to be displayed corresponding to the user's input or selection on the user interface 520, and the processing system 550 also stores a history of games in the memory 560. The processing system is connected to the display 510 by an interface 580 and is connected to the user interface 520 by any standard interface 590. The score keeper 495 also preferably includes an auto save function that stores previous game results in a folder and the processing system 550 preferably time stamps the saved information. The saved and time-stamped information may be recalled from the memory 560 and displayed on the display 510 by the processing system 550 in response to user requests, keyed in on the user interface 520.

The score keeper 495 may further include a program 570 residing within the memory 560 and running on the processing system 550 where the processing system 550 executes the program 570 to calculate, store, recall and display game information. Alternatively, the program 570 may reside on a Read Only Memory (ROM) chip in the processing system 550. The processing system 550 and the program 570 calculate game scores based on the user's input (game information entered through the user interface 520). The program 570 may further include an alarm function for an alarm to be activated at a time set by the user if the score keeper 495 is powered on.

The preferred method of maintaining and retrieving scores of games, including baseball games, includes the following steps: (1) the user enters game information via the user interface 520 located on the housing 500; (2) the score keeper 495 calculates the current game score using the processing system 550 running the program 570; (3) the score keeper 495 displays the game score on the display 510; and (4) the score keeper 495 saves the game score in memory 560 when the game ends. The step of saving of the score in the memory 560 may be performed automatically when the score keeper 495 detects the end of a game, or it may be performed at a user's request. The method of storing and retrieving scores of games may also have an additional step of asking the user to confirm the save. The method may further include recalling the game information and displaying a season history when game information is recalled. The game identification information may include a date stamp indicating the day on which a game was played.

Although the invention has been described in terms of particular embodiments, the embodiments are merely illustrative of an application of the principles of the invention. Numerous modifications may be made and other arrangements may be devised without departing from the spirit and scope of the invention.

1. A storage and display system for storing and retrieving scores of games, comprising:
a hand-held calculator-size housing having a memory, a display viewable by a user, and a processing system for inputting, storing in said memory and displaying on said display ball game information; and
a user interface disposed on a surface of said housing and operable by the user to input and recall stored ball game information in said memory;
wherein said processing system causes ball game information displayed on said display to correspond to the user's inputs and selections.

2. The storage and display system of claim 1 wherein a history of ball games is stored in said memory.

3. The storage and display system of claim 1 wherein said processing system calculates and updates a ball game score based on the user's input of ball game information.

4. The storage and display system of claim 2 wherein said processing system time stamps the history of ball games.

5. The storage and display system of claim 1 wherein the user inputs information by operating menu-selecting, balls, strikes, outs, base-runner-out, runs, cursor and correction function keys.

6. The storage and display system of claim 5 wherein there are no other function keys on said housing.

7. A method of storing and retrieving scores of baseball games using a storage and display system having a hand-held calculator-size housing, a set of keys disposed on a surface of said housing, a processing system in conjunction with a memory residing within said housing, and a display coupled to said processing system and viewable by a user, said method comprising the steps of:
using the set of keys operable by the user to enter, store and recall baseball game information;
using the processing system for executing a program to calculate a baseball game score based on information entered by the user;
displaying the calculated baseball game score on the display; and
saving the entered baseball game information in the memory.

8. The method of storing and retrieving scores of baseball games of claim 7 wherein the set of keys includes menu-selecting, balls, strikes, outs, base-runner-out, runs, cursor and correction function keys.

9. The method of storing and retrieving scores of baseball games of claim 8 wherein there are no other function keys on said housing.

10. The method of storing and retrieving scores of baseball games of claim 7 wherein baseball game information is automatically retained at the end of the game.

11. The method of storing and retrieving scores of baseball games of claim 7 wherein the baseball game information that is entered includes Little League information.

12. The method of storing and retrieving scores of baseball games of claim 7 further comprising the step of recalling and displaying a season history when game information is recalled.

13. The method of storing and retrieving scores of baseball games of claim 7 wherein game information that is stored includes a date stamp indicating when a game was played.

14. A storage and display system for storing and retrieving scores of baseball games, comprising:
a hand-held calculator-size housing having a memory, a display viewable by a user, and a processing system for inputting, storing in said memory and displaying on said display baseball game information; and
a user interface having a set of function keys disposed on a surface of said housing and operable by the user to input and recall stored baseball game information in said memory;
wherein said processing system causes baseball game information displayed on said display to correspond to the user's inputs and selection; and
wherein the set of function keys includes menu-selecting, balls, strikes, outs, base-runner-out, runs, cursor and correction function keys.

15. The storage and display system of claim 14 wherein a history of baseball games is stored in said memory.

16. The storage and display system of claim 14 wherein said processing system calculates and updates a baseball game score based on the user's input of baseball game information.

17. The storage and display system of claim 16 wherein said processing system time stamps the history of baseball games.

18. The storage and display system of claim 14 wherein there are no other function keys on said housing.
